(19) United States
(12) Patent Application Publication
(10) Pub. No.: US 2024/0076852 A1
(43) Pub. Date: Mar. 7, 2024

(54) Utility Vehicle with Automatic Shift Control

(71) Applicant: Wacker Neuson America Corporation, Menomonee Falls, WI (US)

(72) Inventor: Donovan Knutson, Slinger, WI (US)

(21) Appl. No.: 17/901,275

(22) Filed: Sep. 1, 2022

(51) Int. Cl. E02F 9/22; B62D 55/06; E02F 9/02; E02F 9/20; F16H 39/00; F16H 61/435; F16H 61/47

(52) U.S. Cl. CPC E02F 9/2253; B62D 55/06; E02F 9/02; E02F 9/2004; E02F 9/2228; E02F 9/2235; E02F 9/2246; F16H 39/00; F16H 61/435; F16H 61/47; E02F 9/2292; E02F 9/2296

(57) ABSTRACT

A hydraulically driven utility vehicle, such as a wheel loader or track loader, can automatically shift between two or more operating speed ranges based on prevailing operating conditions. The default condition may be a low speed range, and the vehicle may shift into a high speed range only if an output speed of the vehicle's hydraulic drive motor exceeds a designated threshold. The designated threshold may, for example, be a designated percentage of maximum speed. The machine may automatically shift back to the lower speed range if the output speed of the hydraulic drive motor drops beneath a second designated threshold that may lower than the first designated threshold. Other operating conditions, such as commanded speed, engine load and engine speed, may also be taken into account when determining whether to auto-shift.

### BACKGROUND OF THE INVENTION

### 1. Field of the Invention

The present invention relates to utility vehicles such as wheel loaders and track loaders and, more particularly, relates to a utility vehicle that shifts automatically between speed ranges depending on prevailing vehicle operating conditions. The invention additionally relates to a method of using such a vehicle.

### 2. Discussion of the Related Art

Utility vehicles have been widely adopted in a variety of industries including construction, landscaping, recycling, and agriculture. One class of these vehicles includes material handling vehicles such as compact skid steer loaders and track loaders. The size, power, and complexity of these machines has increased over time. These increases have driven an increase in the use of electronic over hydraulic (EH) drive control functions. These machines are operated using one or more controllers such as joystick(s). Movement of the controller(s) generates electric signals that are used by an electronic controller to control a hydraulic drive to operate the vehicle's propulsion system and possibly other systems such as dumping, digging, and/or digging tools. The hydraulic drive typically includes a hydrostatic pump and two hydraulic drive motors, one associated with each driven track or wheel. The pump assembly has one or more swash plates that can be electronically actuated to vary pump output to the drive motors to control propulsion.

Utility vehicles often are capable of being propelled in both low speed range and high speed range. The maximum speed of the vehicle in the selected speed range, as well as its responsiveness within that speed range, differ from operation in the other speed range. Low speed range operation provides a relatively low maximum speed and correspondingly low acceleration, providing smooth, precise propulsion control at a worksite. High speed-range operation provides a relatively high maximum speed and correspondingly high acceleration, permitting rapid transport between worksites at the cost of making it more difficult to move precisely while digging, dumping, etc. Typical utility vehicles have a low speed range maximum value of 6-7 mph and a high speed range maximum value of about 10-11 mph.

Speed ranges historically were selected manually using a button or switch. This manual selection lead to “jerky” operation during upshifting, i.e., when selecting high-speed range while operating in the low-speed range, particularly if the engine was operating under low speed conditions. Manual upshifting also could result in the “bogging down” of the engine if the engine load was too high to accommodate the increased load required to rapidly accelerate to high speeds. Manual downshifting also could result in “jerky” operation due to rapid deceleration. Noticeable engine revving also could occur as a result of manual downshifting.

In addition, in practice, operators often do not frequently shift between speed ranges but, instead, operate the machine almost continuously in either the low speed range or the high speed range. If the machine is left in the low speed range, high tractive effort will be available for digging, and fine control will be available for precise movements; but travel speed between worksites will be unnecessarily limited. If the machine is left in high speed range, the machine will struggle to dig or move soil effectively. Further, the machine also will be operating at very high drive pressures, unnecessarily adding additional stress to the machine's mechanical and hydraulic systems.

Systems have been designed that implement automatic or semi-automatic shifting between speed ranges for various reasons. For example, proposals have been made to provide for automatic downshifting from high-speed range operation if the operator is also controlling excavators or other workpieces that typically are only operated when the vehicle is operating in the low speed range. As another example, proposals have been made to provide for automatic downshifting to provide for a smoother transition between speed ranges when the engine is operating at high speeds. However, no known previous approaches have provided for smooth automatic upshifting and downshifting across the operational spectrum of a utility vehicle.

The need therefore has arisen to provide a utility vehicle that provides for both automatic speed range selection control, i.e., smooth upshifting and downshifting, depending on at drive speed.

The need additionally has arisen to provide a utility vehicle with automatic speed-range selection control that, from an operator's standpoint, approximates the smooth transitions between speed-ranges provided by continuously variable transmissions.

The need also has arisen to provide for an improved technique for automatically shifting between speed-ranges in a utility vehicle.

### SUMMARY OF THE INVENTION

In accordance with an aspect of the invention a utility vehicle, such as a wheel loader or a track loader, includes: a chassis; at least first and second laterally spaced driven ground supports, such as wheels or tracks, that support the chassis on the ground; an engine that is supported on the chassis; and a hydraulic system. The hydraulic drive system includes a hydraulic drive motor that is operatively coupled to the engine and to at least one of the ground supports and that is configured to drive the ground support(s) to propel the vehicle over the ground. The drive motor is operable in at least first and second speed ranges, the second speed range producing a higher motor output speed for a given hydraulic flow than the first speed range. A drive control system is provided that includes an electronic controller and a manually actuated drive command device, such as a joystick. The drive command device generates a drive command signal having a magnitude that is dependent upon a degree of actuation of the drive command device. The electronic controller uses that drive command signal to control the hydraulic drive motor to supply motive power to the at least one motive drive device. The electronic controller is configured to cause the hydraulic drive motor to automatically shift from the first speed range to the second range only if an output speed of the hydraulic drive motor exceeds a designated threshold. The designated threshold may, for example, be a designated percentage of maximum speed.

In the most typical case of a two-speed range system operable in low speed and high speed ranges, the system defaults to low speed range operation and automatically upshifts to the high speed range only if the drive motors exceed the designated threshold speed and, more typically, if other conditions are met as well.

The designated threshold may be a first speed threshold, and the electronic controller may be configured to cause the drive motor to automatically shift from the second speed range to the first speed range when the output speed of the hydraulic drive motor drops beneath a second designated speed threshold that is lower than the first designated speed threshold. In one example, the first and second speed thresholds are 90% and 60%, respectively, of maximum motor speed.

The electronic controller may additionally be configured to prevent the drive motor from automatically shifting from the first speed range to the second speed range unless a user commands for a drive motor speed that is above a designated commanded speed threshold.

In the most typical case in which right and left ground supports are each driven by a respective hydraulic drive motor, auto-upshifting is prevented unless an average speed of the outputs of the first and second drive motors exceed a designated threshold speed.

The electronic controller may also cause an automatic downshift under some operating conductions. The electronic controller thus may additionally be configured to cause the drive motor to automatically shift from the second speed range to the first speed range upon initiation of a counter-steering operation and/or to prevent the drive motor from automatically shifting from the first speed range to the second speed range during reverse travel unless an operator enters a command permitting such shifting. As another example, the electronic controller may additionally be configured to cause the drive motor to automatically shift from the second speed range to the first speed range if engine speed drops beneath a designated speed threshold or if engine load rises above a designated load threshold.

Also disclosed is a method of operating a utility vehicle having some or all of the characteristics described above.

These and other features and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Exemplary embodiments of the invention are illustrated in the accompanying drawings in which like reference numerals represent like parts throughout, and in which:

FIG. 1 is a side elevation view of a material handling machine in the form of a compact track loader incorporating a drive limiting control system constructed in accordance with an embodiment of the present invention;

FIG. 2 schematically illustrates the hydraulically and electronically controlled components of the vehicle of FIG. 1;

FIG. 3 is a flowchart of the operation of the propulsion control system of the vehicle of FIGS. 1 and 2; and

FIGS. 4A and 4B collectively show a family of curves plotting drive command inputs and outputs at various times during vehicle operation.

### DETAILED DESCRIPTION OF THE PREFERRED EMBODIMENTS

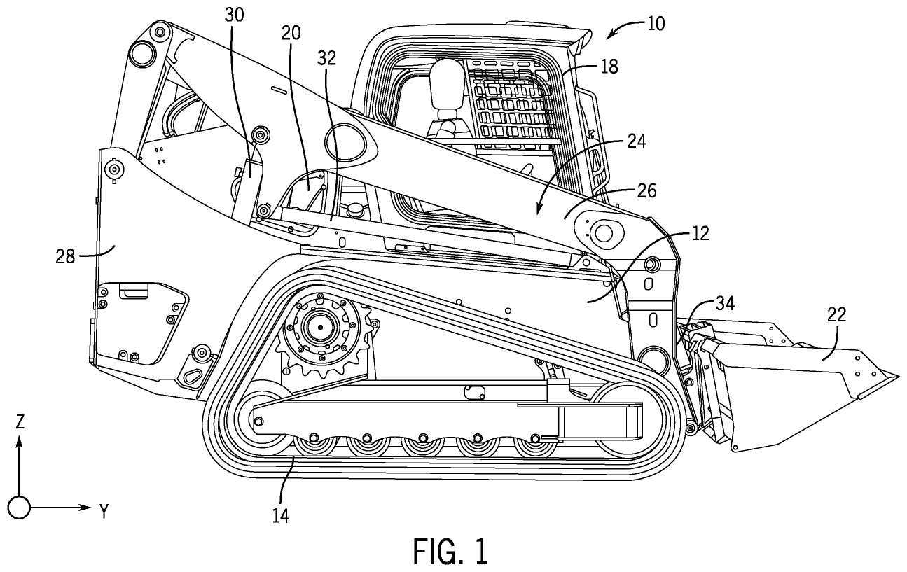

Referring to the drawings and initially to FIG. 1, a utility vehicle or machine 10 is illustrated that is fitted with an automatic shift control system constructed in accordance with the present invention. The illustrated vehicle 10 is a track loader having a vertical lift arrangement. However, the concepts discussed herein apply equally to a track loader having a radial lift arrangement, as well as to wheel loaders and other machines having manually actuated drive controls.

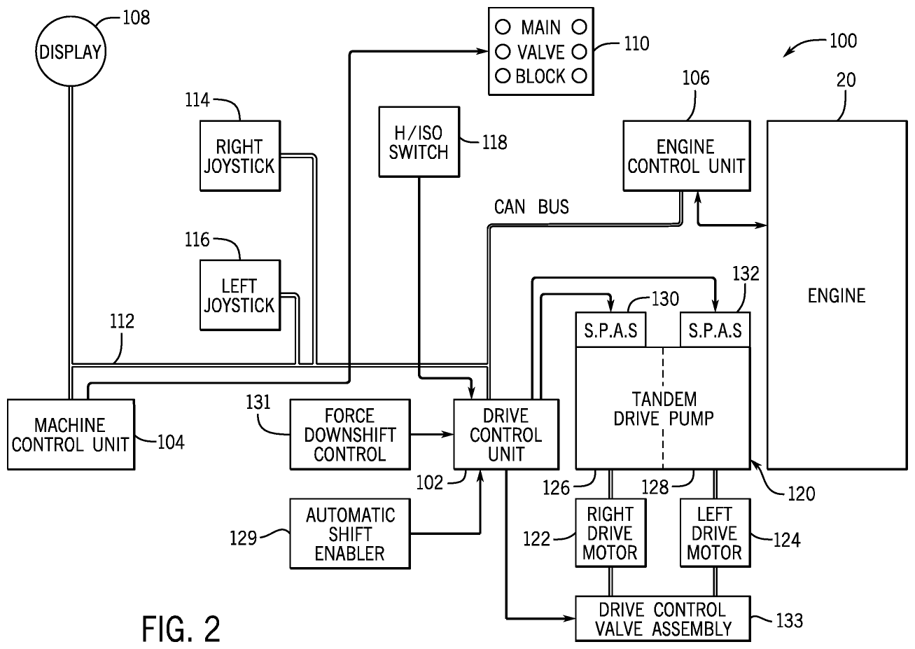

The illustrated machine 10 includes a chassis or frame 12 movably supported on the ground by left and right ground supports. In this example, the ground supports are tracks, one of which is illustrated at 14. The frame 12 supports an operator's cab 18, an engine 20, and all electronic and hydraulic control systems required to propel the machine 10 and to control its powered devices. The frame 12 may be stationary relative to tracks 14, or may be a platform that is mounted on a subframe so as to rotate about a vertical axis relative to the subframe to permit repositioning of the booms 26 relative to the subframe. Located within the cab 18 are a seat and controls (not shown) for operating all components of machine 10. These controls typically include, but are in no way limited to, a throttle and one or more pedals, levers, joysticks, or switches, some of which are discussed below with reference to FIG. 2.

Still referring to FIG. 1, a bucket 22 is mounted on the frame 12 so as to be liftable relative to the frame 12 via a pair of opposed boom assemblies 24, only one of which is illustrated. Each boom assembly 24 is identical, consisting of a boom 26, a boom support assembly 28, a lift cylinder 30, and a link 32. As is generally known in the art, extension and retraction of the lift cylinders 30 raise and lower each of the booms 26 about its rear end, with the links 32 constraining boom movement to more purely vertical movement than otherwise would be possible. The bucket 22 can be tilted relative to the booms 26 and thus relative to the frame 12, via a pair of left and right opposed double acting hydraulic tilt cylinders, only one of which is shown at 34.

An example of drive system and other control systems with which the vehicle is fitted now will be described. The illustrated embodiment includes an electric over hydraulic (EH) drive system and, more specifically, a hydrostatic drive system. All such systems are characterized by a motive drive device that drives the tracks or wheels to propel the vehicle; and a variable output drive control system that is controllable, depending on signals generated by the joystick(s) or other drive command devices, to supply power to the motive drive device at a controlled magnitude and direction. The drive control system is controlled by a drive control unit that is responsive to generated drive command signals. As discussed in more detail below in connection with the particular hydrostatic drive system detailed herein, the drive control unit is configured to cause the drive control system to supply power to the left and right motive drives. In the specific non-limiting example that will now be detailed, shown in FIG. 2, two motive drives are provided in the form of respective portions 126 and 128 of a tandem pump.

A particular hydrostatic drive-based propulsion system with which the described automatic shift control can be implemented is illustrated using a drive control unit 102 shown schematically in FIG. 2. That system is part of a larger control system 100 that includes a machine control unit 104 that controls the work devices of the machine such as lift, tilt and auxiliary devices, and an engine control unit 106 that has the ability to control the engine 20 and to relay information concerning the current operational state of the engine to one or both of the other control units 102 and 104. These control units may comprise individual electronic controllers (ECUs). Alternatively, many of the modules and logical structures described are capable of being implemented in software executed by a single ECU or of being implemented in hardware using a variety of components. Terms such as “controller” may include or refer to both hardware and/or software. Thus, the invention should not be limited to the specific examples or terminology or to any specific hardware or software implementation or combination of software or hardware.

Also shown in FIG. 2 are a display 108 and a main valve block 110. The display 108 may be a purely passive display that indicates the current operational state of the vehicle 10 including, for example, operational modes, engine RPM, etc. Display 108, or another display associated with it, may also take the form of a touch screen or other device providing operator controls. The main valve block 110 comprises a system of EH valves that are actuatable to control bucket lift, bucket tilt, and auxiliary functions of the vehicle 10.

As for the system's electronics, a CAN BUS 112 or other wired or wireless communication link or combination of communication links that permit communication between the machine control unit 104, the drive control unit 102, and the engine control unit 106. Each of these components can pass data to the other components connected to the CAN BUS 112. For example, as described in greater detail below, the left and right joysticks 114 and 116 transmit data (e.g., positional data, data related to the actuation of buttons included on the joysticks, etc.) to the drive control unit 102.

FIG. 2 also illustrates a pair of manually actuated drive command devices which, when actuated, generate drive command signals that are transmitted to the drive control unit 102. In the embodiment shown in FIG. 2, the drive command devices include a right joystick 114 and a left joystick 116 which communicate with at least the drive control unit 102, and possibly one or both of the machine control unit 104 and the engine control unit 106, via the CAN BUS 112. However, alternative drive command devices, such a steering wheel, one or more pedal(s), and/or one or more lever(s), could be employed instead of or in addition to the joysticks 114 and 116. The joysticks 114 and 116 of this embodiment are movable to drive the machine. In the current implementation, the joysticks are both dual axis joysticks moveable both along a fore and aft or “Y” axis or a side-to-side or “X” axis. The joysticks 114, 116 can be operated in one of two modes by actuation of a switch 118. In the first, “H” mode, drive control is achieved solely through motion along the Y axis, with steering being a function of differential positioning of the joysticks along that axis. In the “ISO” mode, one joystick (typically the left joystick 116) controls all propulsion, with movement along the Y axis controlling straight travel and movement along the X axis controlling turning. The other joystick (typically the right joystick 114) controls other functions such as bucket lift and tilt. In either event, movement of the operative joystick(s) from a neutral joystick generates a signal that increases from 0 in the neutral position to a maximum value at maximum displacement. The drive control unit 102 receives the generated drive command signals and transmits a control signal to the pumps 126 and 128.

Still referring to FIG. 2, the hydrostatic drive includes a hydrostatic pump assembly 120 having independent outputs for hydraulic drive motors 122 and 124 for the right and left tracks, respectively. The pump assembly 120 may comprise two (right and left) variable displacement pumps 126 and 128. These pumps are characterized by being able to provide a variable output depending on the position of an electronically actuated pump control device. Typical of such pumps is an “axial piston” pump, the output of which is varied by rotating a pump control device in the form of a swash plate. Each swash plate is driven under control of a servo-piston whose position is controlled by one or more solenoid valves. The swash plate is rotated from a 0 position to increase pump output by delivery of a “pump output control signal” to the swash plate solenoids. Delivery of appropriate pump output control signals to the swash plate control solenoids causes the servo-piston to rotate the swash plate either clockwise or counterclockwise from a zero position, in which no fluid is supplied to the associated drive motor 122 or 124; to a maximum position that results in the delivery of maximum fluid pressure to the drive motors 122 and 124 and propulsion of the associated track at full speed in either the forward or reverse directions. The pump output control signals that are delivered to the swash plate control solenoids are PWM signals. The magnitude of the PWM signals is generated by the drive control unit 102 based on the drive command signals generated by the joysticks 114 and/or 116. The swash plate positions may be monitored by swash plate position sensors 130 and 132.

Examples of pump controls applicable to the present system are electrical Displacement Control (EDC) and Non-Feedback Proportional Electric Control (NFPE). In EDC, solenoids on each side of three-way four porting spool valve are controlled to vary an applied force on a spool that ports hydraulic pressure to a double acting servo-piston. Differential pressure across the servo-piston rotates the swash plate. Pump output varies essentially linearly with swashplate displacement. Pump output is dependent on pump flow rate and vehicle speed. In NFPE, control signals activate one of two proportional solenoids that port charge pressure to either side of the pump servo-cylinder. Pump displacement is proportional to the solenoid current signal level, but also depends upon pump input speed and system pressure. This dependency provides a power limiting function by reducing the pump swashplate angle as system pressure increases. Under both control schemes, pump output is dependent at least in part on the input control signal.

Each of the drive motors 122 and 124 may be of the so-called “radial piston” type with a fixed displacement. The shifting of each motor is accomplished by turning off flow to a percentage of the motor flow passages or parts of the rotating group. This shift involves a discontinuous change in displacement since these motors do not have a swash plate. Rapid adjustment of the positions of the swash plates on the pumps 126 and 128 can rapidly change the drive pump displacement to counteract the rapid change in drive motor displacement upon switching from the low speed range to the high speed range, providing for a smooth transition even at high travel speeds. It should be noted that the automatic shift control concepts described herein also could work with variable displacement drive motors such as axial piston type drive motors.

Still referring to FIG. 2, a drive control valve assembly or motor shifting valve 133, controlled by the drive control unit 102, effects switching of the drive motors 122 and 124 between the high and low speed ranges. The illustrated track loader may be capable of traveling 0-6.5 mph in low speed range and 6-10 mph in high speed range; though these values may vary with many factors, including the characteristics of a given vehicle and designer preference. A switch or other control 128 can be manually actuated to enable automatic shift control. Another control 131, such as a switch on one of the joysticks 114 or 116 or an icon on the display 108, can be actuated to control the drive control valve assembly 133 to force a downshift when the machine 10 is operating in the high speed range. It is also conceivable that this or another switch could force an upshift control, though a forced upshift could lead to adverse consequences many designers would prefer to avoid.

When auto-shifting is enabled by operation of switch 129, the control unit 102 is configured and programmed to automatically shift between speed ranges under conditions that assure smooth shifting of the type generally experienced by operation of an automatic transmission, avoiding or reducing speed surges or drops that otherwise could occur. The system may be configured to operate in low speed range by default and to shift to a high speed range only when designated conditions are met. These conditions may be varied and relatively numerous. For purposes of the present discussion, the conditions will include at least rising of drive speed, as represented by the speed of the drive motors, above a designated speed threshold. Other criteria that may be considered include commanded speed, engine load, and secondary thresholds described below. The criteria that are considered, and the threshold of a given criterion, may differ depending on whether the system is upshifting or downshifting.

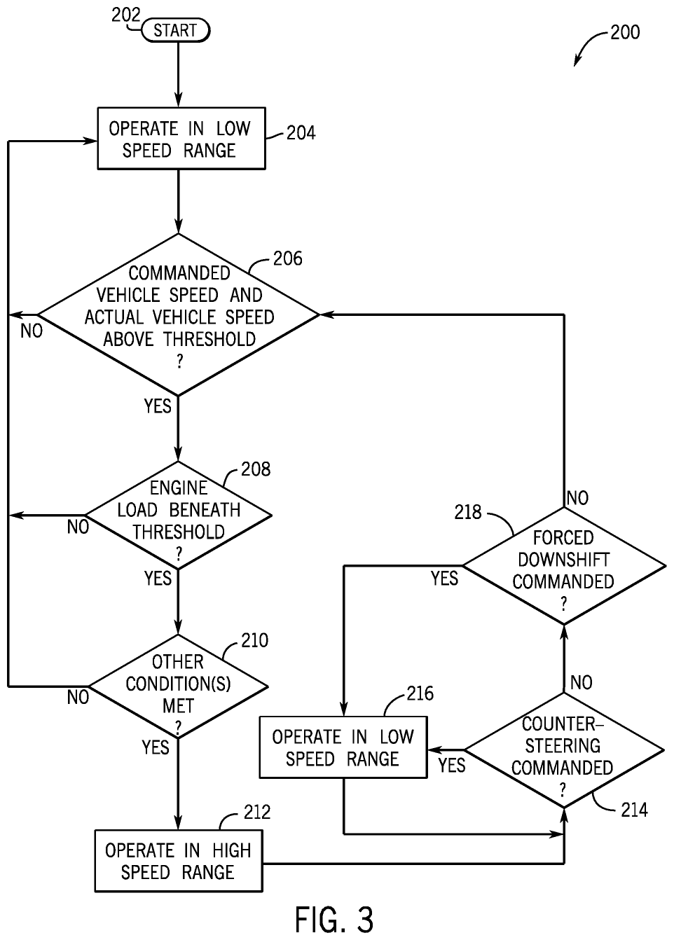

Referring to FIG. 3, an example of a process 200 for automatic shift control or “autoshift” control is illustrated that uses this control scheme. The process 200 proceeds from START in block 202 to control operation in low speed range. The system operates in this low speed range as a default because most machines are used predominately for work operations performed at low speeds, and need to travel at high speeds only when moving from location to location within the worksite.

Then, in block 204 the process 200 determines whether the drive motor speed is above a designated threshold. In a typical system in which each track or wheel is driven by a separate drive motor under control of a separate joystick, “drive motor speed” may refer to the absolute value of the average speed of the two drive motors 122 and 124. These speeds may be indicated by the position of the swash plates controlling operation of the associated pump 126 and 28. Commanded speed also may be compared to 100% of maximum. “Commanded speed” in this regard may be the absolute value of the average stroke or position of the joystick(s) 114 and 116 as compared to 100% of maximum. The monitored swash plate positions can be used to determine the output speed of the drive motors 122 and 124. Vehicle speed is a function of these drive motor output speeds and can be determined from them. The threshold(s) for the commanded and actual drive motor speeds may be the same as or different from one another. In the specific example discussed herein, they are both 80-100%, and more typically 90% of maximum. In one implementation, assuming that all other conditions for auto-upshifting are met, the upshifting is delayed until the vehicle travels above the threshold speed for brief time of, for example, 0.25 sec. to 0.5 sec, in order to avoid rapid cycling between range settings when the speed(s) is/are very near the threshold(s). Hence, in this example, the process inquiries in block 204 as to whether the average commanded motor output speeds and thus the actual average motor output speeds are above respective thresholds. If the answer to this inquiry is NO, the routine 200 returns to block 202, and the vehicle 10 continues to operate in the low speed range.

If, on the other hand, the answer to the inquiry of block 204 is YES, indicating that both commanded drive motor speed and actual drive motor speed are above their respective speed thresholds, the routine 200 proceeds to block 206 to determine whether or not the engine load is beneath a designated threshold of, for example, 60% to 80%, and more typically 70%, of maximum load. Auto-upshifting is prevented if the engine load is above this threshold (i.e., a NO answer to the inquiry) because upshifting necessarily increases the load on the engine, which can result in a noticeable bogging down of the machine if the engine is incapable of rapidly responding to the increased load demand. Conversely, if the answer to inquiry Block 206 is YES, auto-upshifting is permitted, either immediately or, as in the illustrated embodiment, if other conditions are also met. The checking for other conditions is reflected by block 208. These conditions may include some or all (depending on designer preference rather than prevailing circumstances) of:

Attachment Operation: Many machines can operate powered attachments, sometimes called auxiliaries, such as augers, snowblowers, brushes, brooms, and mowers. These attachments typically are powered hydraulically via an auxiliary hydraulic power control system. In one implementation, auto-upshifting is disabled whenever such attachments are being operated. This control typically can be viewed as a safety precaution.

Operator Setting: Auto-upshifting also may be disabled if the operator is not in a designated setting, such as one that is deemed safe to shift or operate at high speeds. For example, auto-upshifting may be disabled if the door of the operator's cab is open or if an operator's presence detector in the vehicle's seat is not actuated.

Engine Stress: As mentioned above, upshifting necessarily places additional load on an engine. If the engine is exhibiting stress as reflected by, for example, engine oil overheating, auto-upshifting is disabled even if all other conditions for auto-upshifting are met.

Hydraulic System Stress: Upshifting also increases demands on a vehicle's hydraulic system. If that system is exhibiting stress as reflected by, for example, high charge oil temperature or low charge oil pressure, auto-upshifting is disabled even if all other conditions for auto-upshifting are met. Conversely, auto-upshifting also may be disabled if the hydraulic fluid temperature is beneath a threshold at which the system's hydraulics function nominally, thus requiring the system to suitably “warm up” before the vehicle auto-upshift.

Operator Selectable Conditions: Auto-upshifting also may be enabled or disabled depending on specific control operations. For example, using switches or a touchscreen, an operator may be able to choose whether to allow auto-upshifting when traveling in reverse. If auto-upshifting in reverse is enabled, auto-upshifting may performed under either the same or different conditions than it is performed in during forward travel.

Still referring to FIG. 3 with additional reference to FIG. 2, if the answer to the inquiry block 210 is YES, the routine 200 proceeds to block 212, where the drive control unit 102 controls the valve assembly 133 to operate the drive motors 122 and 124 in the high speed range. The routine then proceeds to block 214 to check whether the operator controls the joystick(s) 114 and/or 118 to initiate a “counter-steering” operation in which the left and right tracks are driven to rotate in opposite directions to perform a sharp turn. If so, the routine 200 proceeds to block 216 to force a downshift. The routine 200 then cycles between blocks 214 and 216 until the counter-steering control is terminated, at which point the vehicle can auto-upshift. Block 218 indicates system response to the entry of a forced downshift command using the forced downshift control 131, with a YES response leading to operation at in the low speed range in block 216.

If the operator does not command either counter-steering or a forced downshift, the routine 200 returns to block 206 from block 218, where the inquires of blocks 206+ are repeated. However, the thresholds that trigger auto-downshifting may differ if the machine is operating in the high speed range at the time of inquiry. For example, the system may automatically downshift when the actual drive speed or the commanded drive speed drops below 60% or maximum or when the detected engine load rises above 50% of maximum. The original, higher, thresholds are thereafter employed to retrigger an auto-upshift.

While inquiry blocks 206, 208, and 210 are shown in a specific order, it is contemplated that these decision blocks may occur in any order to result in the same outcomes identified in the flowchart of FIG. 3. The same is true with respect to inquiry blocks 214 and 218,

The auto-shifting controls described in conjunction with FIG. 3 are not all-inclusive. For example, the drive control unit 102 may control the drive control valve assembly 133 to downshift the drive motors 122 and 124 from the high speed ranges to the low speed ranges if the engine torque rises above and is maintained above a threshold, such as a designated percentage of the engine's theoretical torque output. Such auto-downshifting also may occur if the actual engine speed drops beneath a designated amount beneath a commanded engine speed. As still another example, auto-downshifting may occur if the commanded drive speed as determined by the position of the joystick(s) 114 and/or 116 is reduced below a designated threshold and the output of the pumps 126 and 128 also is reduced below a designated threshold.

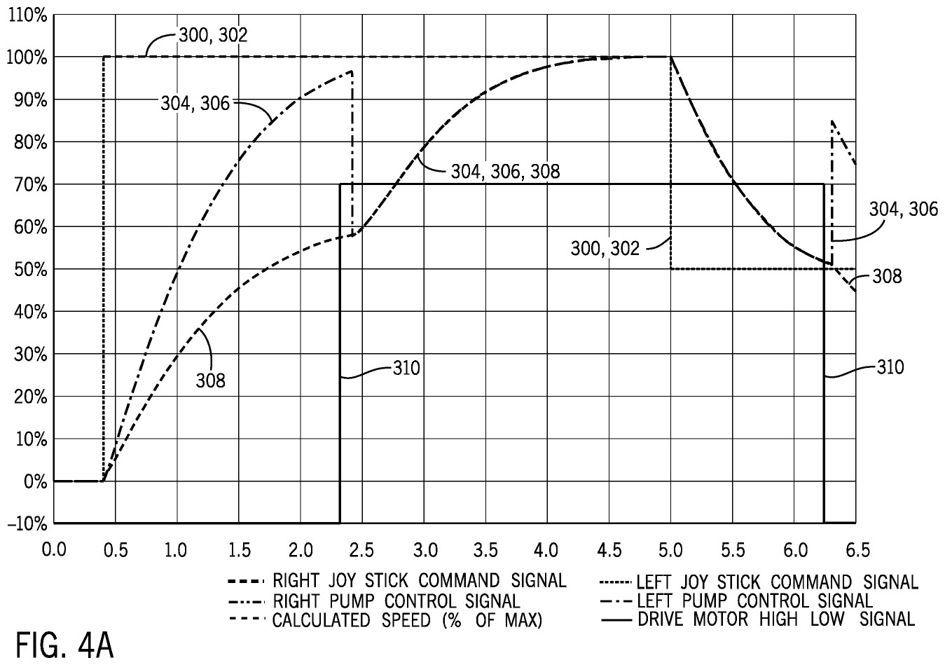

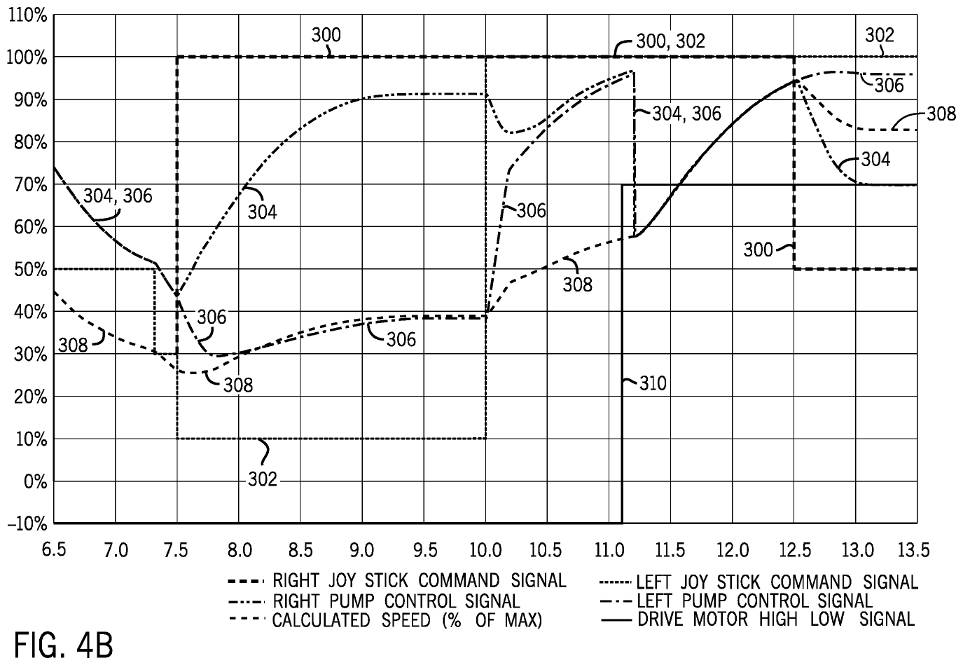

An example of the implementation of the auto-shifting control techniques descried herein is illustrated graphically in FIGS. 4A and 4B. This examples assumes that all conditions for shifting between high and load ranges are met at all times except for the requirements that the actual and commanded drive motor speeds must be above 95% for an auto-upshift and below 60% for an auto-downshift. In this example, auto-upshifting and auto-downshifting occur without delay after the designated commanded and actual drive motor speed thresholds are exceeded. This example also assumes that the vehicle is operating in “H” mode and that the commanded speeds of the right and left drive motors 122 and 124 thus are controlled by the right and left joysticks 114, 116, respectively. In this graph:
a. curves 300 and 302 plot commanded speeds of the right and left drive motors 122 and 124, as a percentage of maximum, vs. time as reflected by the position of the right and left joysticks 114 and 116, respectively;
b. curves 304 and 306 plot the actual speeds of the right and drive motors 122 and 124, as a percentage of maximum, vs. time as reflected by monitored pump swash plate position or otherwise;
c. curve 308 plots the vehicle's calculated speed as a percentage of its maximum; and
d. curve 310 plots the operating speed range of the drive motors (low or high) as determined by the setting of the drive control valve assembly 133.

At about time 0.5 seconds, an operator actuates the joysticks 114 and 116 to command 100% of maximum speed. Curves 300 and 302 thus immediately rise to 100%. Drive motor speeds begin to increase as indicated by rising curves 304 and 306, and vehicle speed also increases as indicated by curve 308. The curves 304 and 306 show that the absolute value of the average drive motor speed surpasses the designated 95% threshold at about time 2.5 seconds, whereupon the controller 102 causes the control valve assembly 126 to force an upshift of the drive motors 122 and 124, as indicated the rise in curve 310. The curves 304 and 306 show that the speeds of the drive motors 122 and 124 decrease in response to the upshift, and then begin to rise. Vehicle speed, as reflected by curve 308, continues to increase without a marked change in slope during this transition period. The demonstrates a smooth auto-shift from low speed range operation to high speed range operation without any dramatic change in acceleration.

Still referring to FIG. 4A, curves 300 and 302 show that the operator continues to command full speed straight-ahead operation until time 5.0, when the operator commands a speed decrease by reducing the stroke of both joysticks 114 and 116. Vehicle speed and drive motor speeds begin to decrease. However, the system does not auto-downshifts until about time 6.25 seconds when the absolute value of the average speed of the drive motors 120 and 122 as reflected by curves 304 and 306 drops below the corresponding speed threshold of 55%. Only at this time do both commanded and actual drive motor speeds drop beneath the designated threshold. Vehicle speed, as denoted by curve 308, decreases without a marked change in deceleration. This again denotes a smooth auto-shifting, in this case from high speed range operation to low speed range operation.

Referring now to FIG. 4B, a command for a left turn is commanded at time 7.5 seconds is indicated by a decrease in curve 302 and an increase in curve 300. The system continues to operate in the low speed range because neither the average commanded speed nor the average actual drive motor speed exceeds the required 95% threshold. At about time 10.0 seconds, curve 302 shows that the left joystick 116 is returned to its maximum stroke to again command full speed, straight-ahead travel. Auto-upshifting does not occur, however, until at about time 11.1 seconds when the average speeds of the drive motors exceeds 95%. The average speed of the drive motors 122 and 124 drops sharply and then increases at a relatively constant rate. Once again, vehicle speed, as reflected by curve 308, does not change sharply but. Drive motor output speeds and vehicle speed continue to increase until after time 12.5 seconds, when the stroke of the right joystick 114 is reduced to effect a gentle left-turn, as indicted by the noted drop in curve 300. This results in a decrease in the output speed of the right drive motor 122 as reflected by curve 302, and a decrease in vehicle speed as reflected by curve 308. The system does not auto-downshift during this turn, however, because the average motor drive speed and the average commanded drive speed both remain above the 55% threshold.

It should be noted that other controls could be implemented instead of or in addition to those discussed herein. For example, the system could be configured such that, when the vehicle is operating in the high speed range, an auto-downshift may occur if the engine torque or load rises above a threshold value, such as a threshold percentage of maximum, for more than a designated period of time.

It should be apparent from the foregoing that the auto-shifting techniques described herein, and variations of those techniques increase operator comfort and safety in providing for smooth transition between operating speed ranges. They also reduce operator fatigue because the operator can focus on operating the machine instead of selecting high and low range. They also tend to reduce wear on the machine because operators often leave the machine in high range when conditions would dictate that the machine should operate in the low speed range. This results in excessively high drive pressures and wear on hydrostatic system components and high engine load. The operator can focus on operating the machine instead of selecting high and low range. Implementing the disclosed auto-shifting techniques also can lead to increased productivity since the machine will likely spend more time operating at a higher travel speed since some operators simply leave the machine in low range to avoid repeatedly actuating the speed range select button.

Although the best mode contemplated by the inventors of carrying out the present invention is disclosed above, practice of the above invention is not limited thereto. It will be manifest that various additions, modifications, and rearrangements of the features of the present invention may be made without deviating from the spirit and scope of the underlying inventive concept.

It should be appreciated that such a development effort might be complex and time consuming, but would nevertheless be a routine undertaking of design, fabrication, and manufacture for those of ordinary skill in the art having the benefit of this disclosure. Nothing in this application is considered critical or essential to the present invention unless explicitly indicated as being “critical” or “essential”.

What is claimed is:

1. A utility vehicle comprising:
a. a chassis;
b. at least first and second laterally spaced, driven ground supports that support the chassis on the ground;
c. an engine that is supported on the chassis;
d. a hydraulic system that is supported on the chassis, the hydraulic system including a hydraulic drive motor that is operatively coupled to the engine and to at least one ground support, the drive motor being configured to drive the at least one ground support to propel the vehicle over the ground, the drive motor being operable in at least first and second speed ranges, the second speed range producing a higher drive motor output speed for a given hydraulic flow through the drive motor than the first speed range;
e. a drive control system including
i. an electronic controller;
ii. a manually actuated drive command device that is electronically coupled to the electronic controller to generate a drive command signal, a magnitude of which is dependent upon a degree of actuation of the drive command device; and
iii. a drive control system that is coupled to the electronic controller and to the drive motor, wherein the drive control system controls the drive motor to supply motive power to the at least one motive drive device, wherein the electronic controller is configured to cause the drive motor to automatically shift from the first speed range to the second range only if an output speed of the hydraulic drive motor exceeds a designated speed threshold.

2. The utility vehicle as recited in claim 1, wherein the designated speed threshold is a designated percentage of maximum speed.

3. The utility vehicle as recited in claim 1, wherein the designated speed threshold is a first designated speed threshold, and wherein the electronic controller is configured to cause the drive motor to automatically shift from the second speed range to the first speed range when the output speed of the hydraulic drive motor drops beneath a second designated speed threshold that is lower than the first designated speed threshold.

4. The utility vehicle as recited in claim 1, wherein the electronic controller is additionally configured to prevent the drive motor from automatically shifting from the first speed range to the second speed range unless a commanded drive motor speed is above a designated commanded speed threshold.

5. The utility vehicle as recited in claim 1, wherein the electronic controller is additionally configured to prevent the drive motor from automatically shifting from the first speed range to the second speed range if at least one of the following conditions is met:
a. a powered auxiliary implement is being operated;
b. the operator is not in a designated setting;
c. the engine is operating under stress;
d. the hydraulic system is operating under stress.

6. The utility vehicle as recited in claim 1, wherein the electronic controller is additionally configured to cause the drive motor to automatically shift from the second speed range to the first speed range upon initiation of a counter-steering operation.

7. The utility vehicle as recited in claim 1, wherein the electronic controller is additionally configured to prevent the drive motor from automatically shifting from the first speed range to the second speed range during reverse travel unless an operator enters a command permitting such shifting.

8. The utility vehicle as recited in claim 1, wherein the electronic controller is additionally configured to cause the drive motor to automatically shift from the second speed range to the first speed range if engine speed drops beneath a designated speed threshold or if engine load rises above a designated load threshold.

9. The utility vehicle as recited in claim 1, wherein
the utility vehicle has first and second hydraulic drive motors associated with the first and second driven ground supports, respectively, wherein
the utility vehicle has first and second drive command devices, each of which is associated with a respective one of the first and second drive motors, and wherein
the electronic controller is configured to cause the first and second drive motors to automatically shift from the first speed range to the second range only if an average output speed of the first and second drive motor exceeds a designated speed threshold.

10. A utility vehicle comprising:
a. a chassis;
b. left and right laterally spaced driven ground supports that support the chassis on the ground;
c. an engine that is supported on the chassis;
d. a hydraulic system that is supported on the chassis and that includes
i. a tandem drive pump including first and second pumps, each being powered by the engine and having an output that can be varied by adjusting a setting of an associated swash plate,
ii. first and second hydraulic drive motors, each of which is coupled to one of the pumps and to a respective one of the grounds supports, and each of the drive motors being operable in a low speed range and a high speed range, and
iii. a drive control valve assembly that is actuatable to switch each of the drive motors between the low speed range and the high speed range thereof;
e. a drive control system including
i. an electronic controller that is electronically coupled to the swash plates and to the drive control valve assembly;
ii. first and second manually actuated drive command devices, each of which is electronically coupled to the electronic controller and is operable to generate a drive command signal, a magnitude of which is dependent upon a degree of actuation of the drive command device; and
iii. a drive control system that is coupled to the electronic controller and to the drive control valve assembly, wherein the electronic controller is configured to cause actuation of the drive control valve assembly to control each of the drive motors to automatically shift from the first speed range to the second range only if an average output speed of the rive motors exceeds a designated speed threshold.

11. The utility vehicle as recited in claim 10, wherein the designated speed threshold is a first speed threshold, and wherein the electronic controller is configured to cause the drive motors to automatically shift from the second speed range to the first speed range when the average output speed of the drive motors drops beneath a second designated speed threshold that is lower than the first designated speed threshold.

12. The utility vehicle as recited in claim 10, wherein the electronic controller is additionally configured to prevent the drive motors from automatically shifting from the first speed range to the second speed range unless an average commanded drive motor speed as reflected by operation of the first and second drive command devices is above a designated commanded speed threshold.

13. The utility vehicle as recited in claim 10, wherein the electronic controller is additionally configured to cause the drive motors to automatically shift from the second speed range to the first speed range if engine speed drops beneath a designated speed threshold or if engine load rises above a designated load threshold.

14. A method of operating a utility vehicle comprising a chassis, at least first and second laterally spaced driven ground supports that support the chassis on the ground, an engine that is supported on the chassis, and a hydraulic system that is supported on the chassis and includes a hydraulic drive motor that is operatively coupled to the engine and to at least one ground support, the method comprising:
a. generating a drive command signal by manually operating a drive command device, the drive command device being electronically coupled to an electronic controller; and
b. in response to generation of the drive command signal, and under control of the electronic controller, controlling the drive motor to drive the at least one ground support to propel the vehicle over the ground, the controlling including causing the drive motor to automatically shift from a first speed range to the second range only if an output speed of the drive motor exceeds a designated speed threshold, the second speed range being higher than the first speed range.

15. The method as recited in claim 14, wherein the designated speed threshold is a first designated speed threshold, and wherein the controlling includes causing the drive motor to automatically shift from the second speed range to the first range when the output speed of the drive motor drops beneath a second designated speed threshold that is lower than the first designated threshold.

16. The method as recited in claim 14, wherein the controlling additionally comprises preventing the drive motor from automatically shifting from the first speed range to the second speed range unless a commanded drive motor speed is above a designated commanded speed threshold.

17. The method as recited in claim 14, wherein the controlling additionally comprises causing the drive motor to automatically shift from the second speed range to the first speed range upon initiation of a counter-steering operation.

18. The method as recited in claim 14, wherein the controlling additionally comprises preventing the drive motor from automatically shifting from the first speed range to the second speed range during reverse travel unless an operator enters a command permitting such shifting.

19. The method as recited in claim 14, wherein the controlling additionally comprises causing the drive motor to automatically shift from the second speed range to the first speed range if engine speed drops beneath a designated speed threshold or if engine load rises above a designated load threshold.
